(19) United States
(12) Patent Application Publication
(10) Pub. No.: US 2023/0371044 A1
(43) Pub. Date: Nov. 16, 2023

(54) ONE-TO-ONE BROADCAST SIDELINK COMMUNICATION PROTOCOL VEHICULAR COMMUNICATIONS

(71) Applicant: QUALCOMM Incorporated, San Diego, CA (US)

(72) Inventors: Yue YIN, Beijing (CN); Yan LI, Beijing (CN); Shuping CHEN, Beijing (CN)

(21) Appl. No.: 18/246,667

(22) PCT Filed: Nov. 26, 2020
(86) PCT No.: PCT/CN2020/131677

§ 371 Date: Mar. 24, 2023

(51) Int. Cl. H04W 72/25; H04W 4/46; H04W 4/06

(52) U.S. Cl. CPC H04W 72/25; H04W 4/46; H04W 4/06

(57) ABSTRACT

Various aspects of the present disclosure generally relate to wireless communication. In some aspects, a user equipment (UE) may receive a plurality of broadcast sidelink communication protocol vehicular communication packets. The UE may process a set of packets of the plurality of broadcast sidelink communication protocol vehicular communication packets based at least in part on a determination that the set of packets are addressed only to the UE. Numerous other aspects are provided.

### FIELD OF THE DISCLOSURE

Aspects of the present disclosure generally relate to wireless communication and to techniques and apparatuses for one-to-one broadcast sidelink communication protocol vehicular communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a plurality of broadcast sidelink communication protocol vehicular communication packets; and processing a set of packets of the plurality of broadcast sidelink communication protocol vehicular communication packets based at least in part on a determination that the set of packets are addressed only to the UE.

In some aspects, a method of wireless communication performed by a UE includes generating a set of broadcast sidelink communication protocol vehicular communication packets addressed only to a receiving UE based at least in part on indicating a receiver identifier (ID) corresponding to the receiving UE in a protocol layer of a broadcast vehicular communication protocol stack; and transmitting the set of broadcast sidelink communication protocol vehicular communication packets.

In some aspects, a UE for wireless communication includes a memory and one or more processors operatively coupled to the memory, the memory and the one or more processors configured to: receive a plurality of broadcast sidelink communication protocol vehicular communication packets; and process a set of packets of the plurality of broadcast sidelink communication protocol vehicular communication packets based at least in part on a determination that the set of packets are addressed only to the UE.

In some aspects, a UE for wireless communication includes a memory and one or more processors operatively coupled to the memory, the memory and the one or more processors configured to: generate a set of broadcast sidelink communication protocol vehicular communication packets addressed only to a receiving UE based at least in part on indicating a receiver ID corresponding to the receiving UE in a protocol layer of a broadcast vehicular communication protocol stack; and transmit the set of broadcast sidelink communication protocol vehicular communication packets.

In some aspects, a non-transitory computer-readable medium storing a set of instructions for wireless communication includes one or more instructions that, when executed by one or more processors of a UE, cause the UE to: receive a plurality of broadcast sidelink communication protocol vehicular communication packets; and process a set of packets of the plurality of broadcast sidelink communication protocol vehicular communication packets based at least in part on a determination that the set of packets are addressed only to the UE.

In some aspects, a non-transitory computer-readable medium storing a set of instructions for wireless communication includes one or more instructions that, when executed by one or more processors of a UE, cause the UE to: generate a set of broadcast sidelink communication protocol vehicular communication packets addressed only to a receiving UE based at least in part on indicating a receiver ID corresponding to the receiving UE in a protocol layer of a broadcast vehicular communication protocol stack; and transmit the set of broadcast sidelink communication protocol vehicular communication packets.

In some aspects, an apparatus for wireless communication includes means for receiving a plurality of broadcast sidelink communication protocol vehicular communication packets; and means for processing a set of packets of the plurality of broadcast sidelink communication protocol vehicular communication packets based at least in part on a determination that the set of packets are addressed only to the apparatus.

In some aspects, an apparatus for wireless communication includes means for generating a set of broadcast sidelink communication protocol vehicular communication packets addressed only to a receiving UE based at least in part on indicating a receiver ID corresponding to the receiving UE in a protocol layer of a broadcast vehicular communication protocol stack; and means for transmitting the set of broadcast sidelink communication protocol vehicular communication packets.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of sidelink communications, in accordance with various aspects of the present disclosure.

FIG. 4 is a diagram illustrating an example of sidelink communications and access link communications, in accordance with various aspects of the present disclosure.

FIG. 5 is a diagram illustrating an example of a broadcast vehicular communication protocol stack, in accordance with various aspects of the present disclosure.

FIG. 6 is a diagram illustrating an example associated with one-to-one broadcast sidelink communication protocol vehicular communications, in accordance with various aspects of the present disclosure.

FIGS. 7 and 8 are diagrams illustrating example processes associated with one-to-one broadcast sidelink communication protocol vehicular communications, in accordance with various aspects of the present disclosure.

FIG. 9 is a block diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

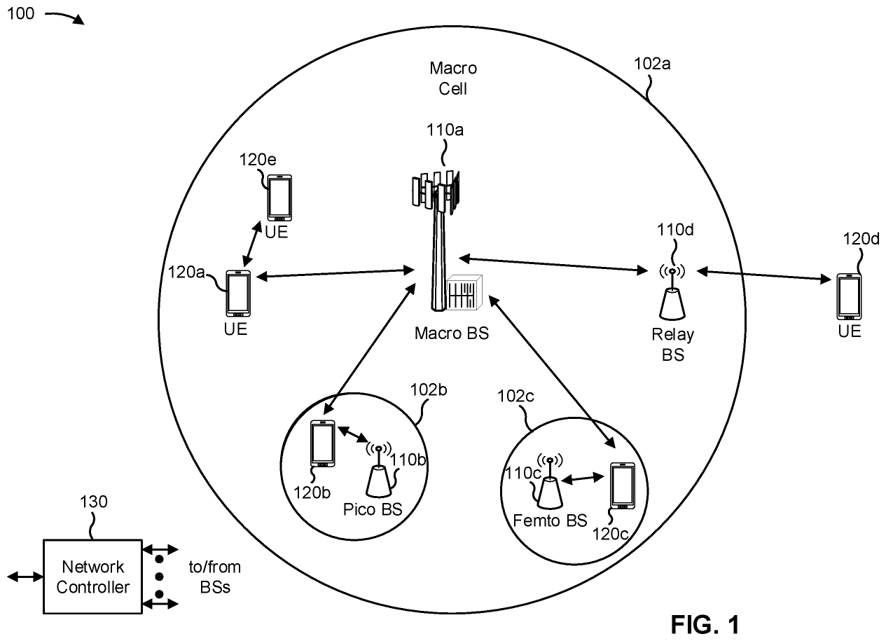

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

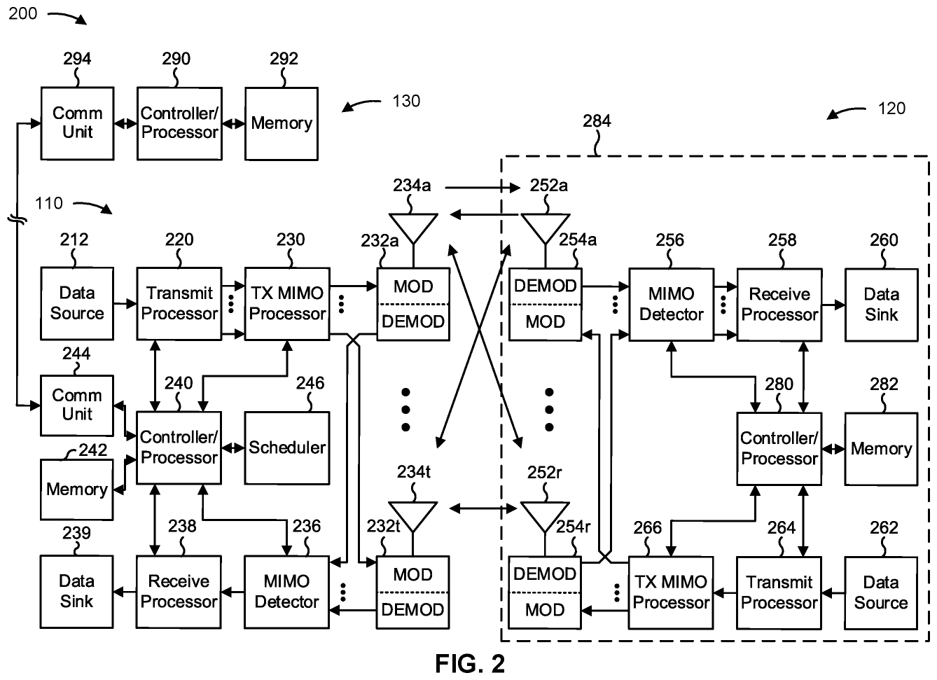

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

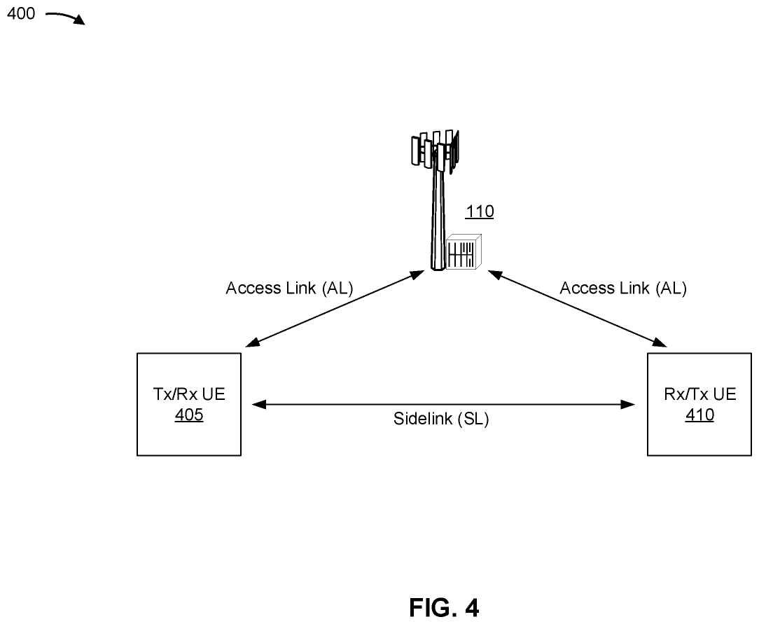

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-6.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-6.

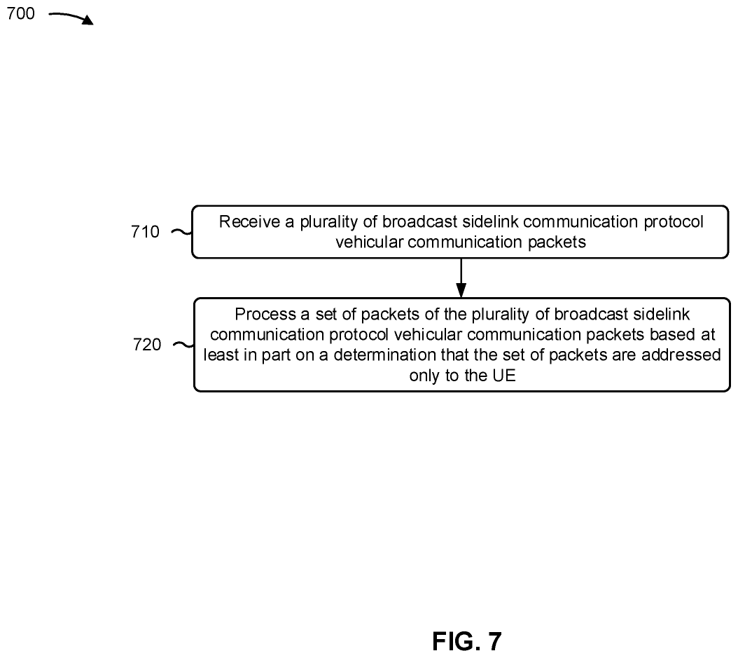

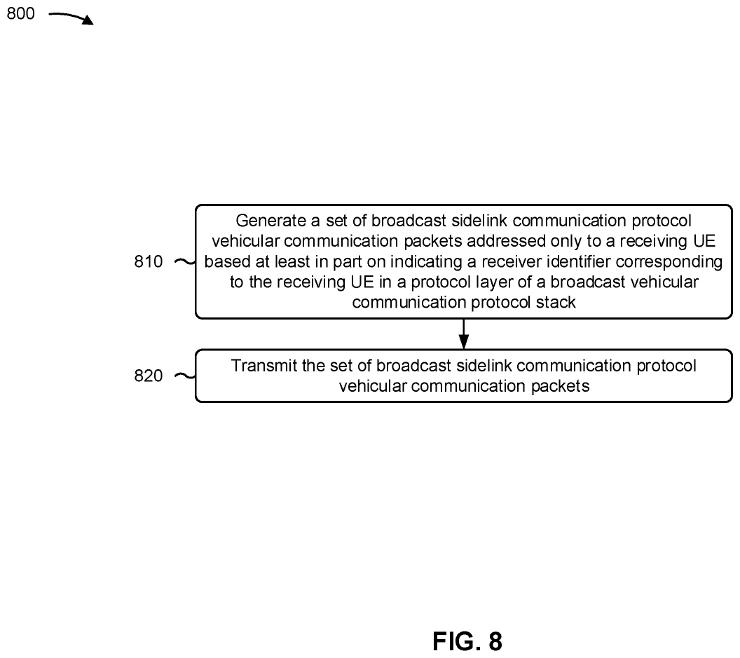

Controller/processor 240 of base station 110, controller/processor 280 of UE 120, and/or any other component(s) of FIG. 2 may perform one or more techniques associated with one-to-one broadcast sidelink communication protocol vehicular communications, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, a UE includes means for receiving a plurality of broadcast sidelink communication protocol vehicular communication packets; and/or means for processing a set of packets of the plurality of broadcast sidelink communication protocol vehicular communication packets based at least in part on a determination that the set of packets are addressed only to the UE. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for determining that the set of packets are addressed only to the UE. In some aspects, the UE includes means for performing a receiver identifier (ID) filtering operation on the plurality of broadcast sidelink communication protocol vehicular communication packets. In some aspects, the UE includes means for determining that the MAC header indicates the receiver ID using a first addressing space of a plurality of addressing spaces, wherein the first addressing space indicates one-to-one communications.

In some aspects, the UE includes means for generating a set of broadcast sidelink communication protocol vehicular communication packets addressed only to a receiving UE based at least in part on indicating a receiver ID corresponding to the receiving UE in a protocol layer of a broadcast vehicular communication protocol stack; and/or means for transmitting the set of broadcast sidelink communication protocol vehicular communication packets. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

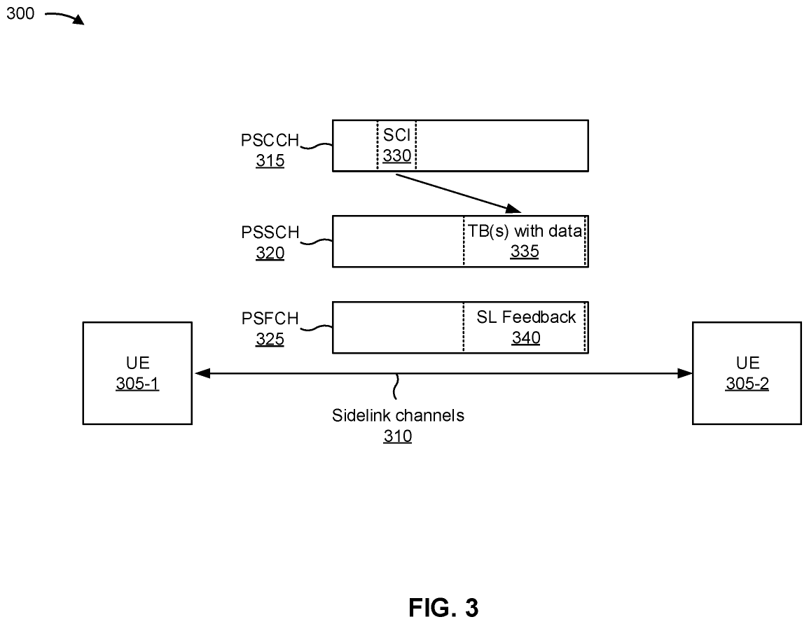

FIG. 3 is a diagram illustrating an example 300 of sidelink communications, in accordance with various aspects of the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, V2P communications, and/or the like), mesh networking, and/or the like. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, symbols, and/or the like) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, spatial resources, and/or the like) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), a scheduling request (SR), and/or the like.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources, channel parameters, and/or the like. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, a modulation and coding scheme (MCS) to be used for the upcoming sidelink transmission, and/or the like. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

FIG. 4 is a diagram illustrating an example 400 of sidelink communications and access link communications, in accordance with various aspects of the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

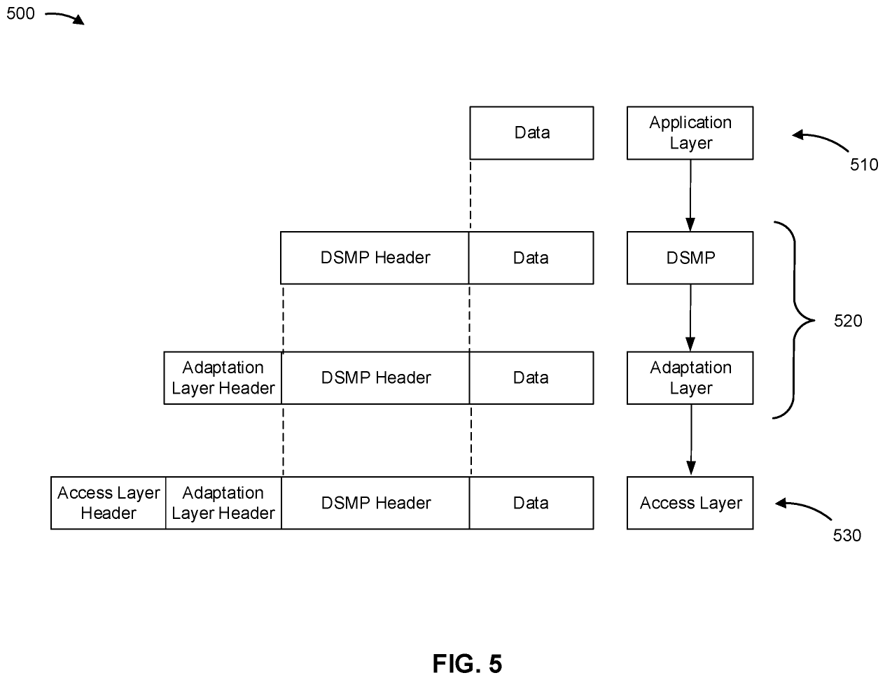

FIG. 5 is a diagram illustrating an example 500 of a broadcast sidelink communication protocol vehicular communication (V2X) protocol stack (referred to herein as a “broadcast vehicular communication protocol stack”), in accordance with various aspects of the present disclosure. In some aspects, for example, the broadcast sidelink communication protocol may be a long term evolution (LTE) protocol. The broadcast vehicular communication protocol stack 500 may be, for example, a protocol stack specified by the China Communication Standards Association.

As shown by reference number 510, the protocol stack includes an application layer that may generate data to be transmitted from one vehicle UE to another device via a sidelink connection. As shown by reference number 520, the protocol stack 500 may include a network layer. The network layer may include a dedicated short range communications (DSRC) short message protocol (DSMP) layer that adds a DSMP header to the data. The DSMP header may include a protocol version indicator, an option indicator, a reserved field indicator, an extension field indicator, and/or other data fields pertinent to the DSMP protocol. The network layer also may include an adaptation layer that may add an adaptation layer header that may include a protocol type indicator.

As shown by reference number 530, the protocol stack 500 also may include an access layer. Together, the network layer and access layer may support V2X communications by facilitating an access (Uu) interface and a sidelink (PC5) interface and network connections corresponding thereto. The access layer may add an access layer header.

In some cases, one-to-one communication may be more useful and efficient than broadcast communication. For example, one-to-one communication may be useful in cases such as paying tolls, communicating with a parking garage unit regarding parking, and/or communicating with a vehicular UE in a police car to provide identifying information, among other examples. However, broadcast communication protocol V2X has been designed for broadcast and does not include communication modes for unicast or groupcast. In some broadcast V2X communications, the target address is a broadcast address mapped from an application identifier (AID).

Aspects of techniques and apparatuses described herein may provide for one-to-one broadcast sidelink communication protocol vehicular communications based at least in part on receiver identifier (ID) filtering. In some aspects, a UE may receive a plurality of broadcast sidelink communication protocol vehicular communication packets that contains a set of packets, and may process the set of packets based at least in part on a determination that the set of packets are addressed only to the UE. For example, the UE may perform a receiver ID filtering operation. The access layer, the network layer, and/or the application layer may be used for receiver ID filtering to support one-to-one communications over broadcast V2X. In this way, broadcast sidelink communication protocol vehicular communications may be used for one-to-one communications in cases in which only one device can benefit from receiving the communication. As a result, aspects may facilitate more efficient broadcast V2X communications, thereby reducing unnecessary network traffic as well as reducing unnecessary processing burdens and battery usage in UEs.

As indicated above, FIG. 5 is provided as an example. Other examples may differ from what is described with respect to FIG. 5.

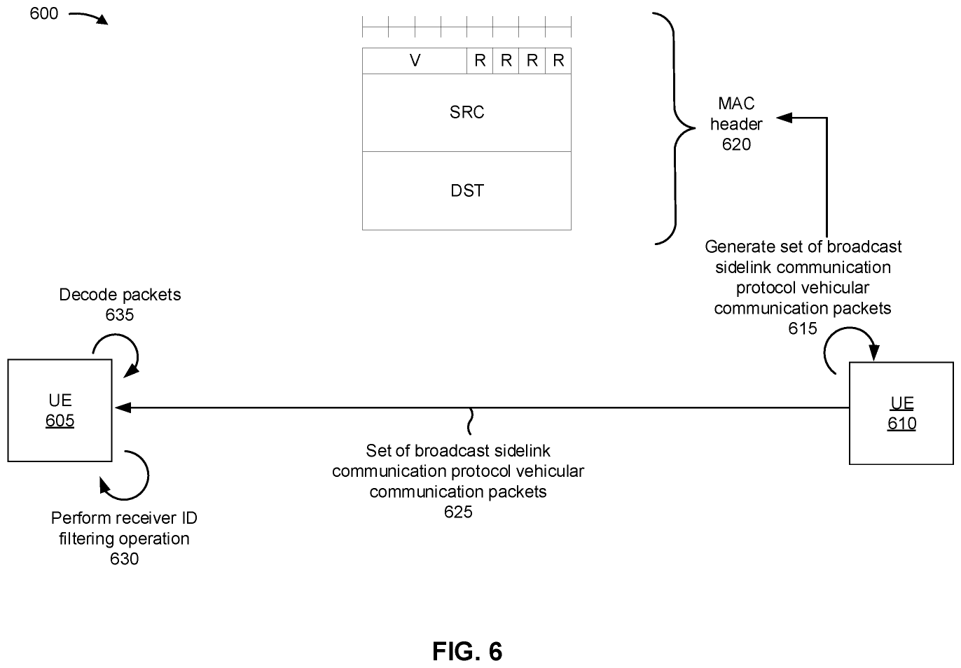

FIG. 6 is a diagram illustrating an example 600 of one-to-one broadcast sidelink communication protocol vehicular communication, in accordance with various aspects of the present disclosure. As shown in FIG. 6, a UE 605 and a UE 610 may communicate with one another. The UE 605 and UE 610 may communicate with one another via a sidelink communication link. In some aspects, the UE 605 and/or the UE 610 may be associated with a vehicle and/or a roadside unit, among other examples.

As shown by reference number 615, the UE 610 may generate a set of broadcast sidelink communication protocol vehicular communication packets. The packets may be addressed only to a receiving UE (e.g., UE 605) based at least in part on indicating a receiver ID corresponding to the receiving UE 605 in a protocol layer of a broadcast vehicular communication protocol stack. In some aspects, the receiver ID may be indicated in an access layer, a network layer, and/or an application layer.

For example, in some aspects, the receiver ID may be indicated in a medium access control (MAC) header 620 associated with the access layer of the broadcast vehicular communication protocol stack. As shown, the MAC header 620 may include a version field (indicated by “V”). A value of the version field may indicate that the packet is a unicast communication. For example, a field value of 0011 may be used to indicate that the packet is a broadcast communication. A different field value (e.g., 0111, 0101, and/or the like) may be used to indicate that the packet is a unicast communication.

The MAC header 620 also may include a source address field (indicated by “SRC”) and a destination address field (indicated by “DST”). The MAC header 620 may indicate the receiver ID using a first addressing space of a plurality of addressing spaces. For example, a first destination addressing space, [0x000000, 0x001FFF], may be used for indicating a receiver ID for broadcast communications, and a second destination addressing space, [0x002000, 0x010000], may be used for indicating a receiver ID for one-to-one communications. In this way, the receiving UE 605 may determine whether the communication is one-to-one or broadcast based at least in part on the addressing space used. Additionally, the receiving UE 605 may determine, based at least in part on the receiving ID, whether the communication is a one-to-one communication intended only for the receiving UE 605.

In some aspects, the receiver ID may be indicated in an application layer of the broadcast vehicular communication protocol stack. For example, the receiver ID may include one or more values of one or more application layer parameters that correspond to the UE 610 and/or the UE 605. The one or more application layer parameters may indicate at least one of: a transaction ID, an application layer ID, a user address, and/or a geolocation of the UE. In some aspects, the one or more application layer parameters may indicate a charging rate associated with an application.

For example, a toll-paying application may indicate a charging rate (e.g., a cost of a toll), a charging rate threshold, and/or a charging rate range such that a parking unit (e.g., a UE associated with a parking lot or garage) may determine whether to charge the toll based on whether the charging rate associated with the parking lot or garage matches the charging rate indicated in the packet.

In some aspects, when using receiver ID filtering at a higher layer such as the application layer, the lower layers (e.g., the access layer, the adaptation layer, the network layer) may still be used in broadcast mode without any changes to the headers. In some aspects, receiver ID filtering may be used at two or more layers.

As shown by reference number 625, the UE 610 may transmit, and the UE 605 may receive, the set of one-to-one broadcast sidelink communication protocol vehicular communication packets. As shown by reference number 630, the UE 605 may perform a receiver ID filtering operation on the plurality of broadcast sidelink communication protocol vehicular communication packets to determine whether the packets are intended only for the UE 605. As shown by reference number 635, the UE 605 may decode the packets and/or perform an action based at least in part on decoding the packets.

As indicated above, FIG. 6 is provided as an example. Other examples may differ from what is described with respect to FIG. 6.

FIG. 7 is a diagram illustrating an example process 700 performed, for example, by a UE, in accordance with various aspects of the present disclosure. Example process 700 is an example where the UE (e.g., UE 605) performs operations associated with one-to-one broadcast sidelink communication protocol vehicular communications.

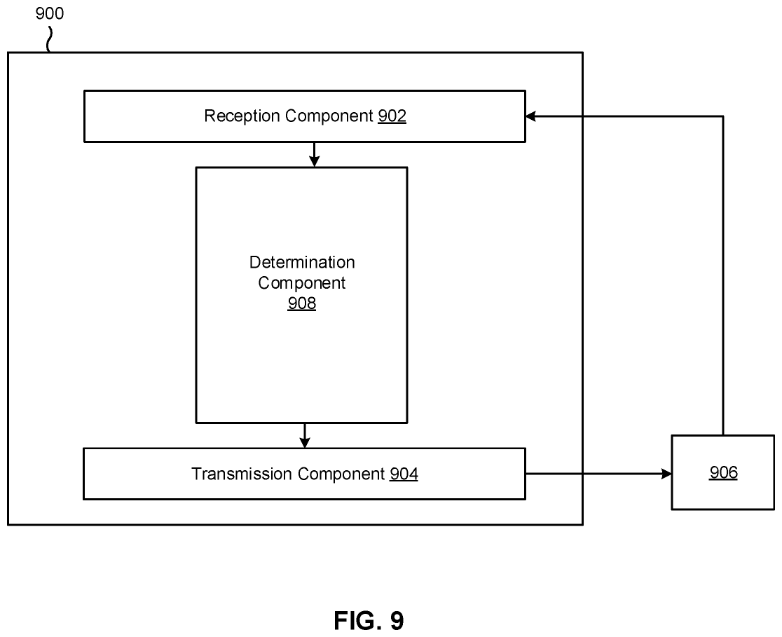

As shown in FIG. 7, in some aspects, process 700 may include receiving a plurality of broadcast sidelink communication protocol vehicular communication packets (block 710). For example, the UE (e.g., using reception component 902, depicted in FIG. 9) may receive a plurality of broadcast sidelink communication protocol vehicular communication packets, as described above.

As further shown in FIG. 7, in some aspects, process 700 may include processing a set of packets of the plurality of broadcast sidelink communication protocol vehicular communication packets based at least in part on a determination that the set of packets are addressed only to the UE (block 720). For example, the UE (e.g., using determination component 908, depicted in FIG. 9) may process a set of packets of the plurality of broadcast sidelink communication protocol vehicular communication packets based at least in part on a determination that the set of packets are addressed only to the UE, as described above.

Process 700 may include additional aspects, such as any single aspect or any combination of aspects described below and/or in connection with one or more other processes described elsewhere herein.

In a first aspect, process 700 includes determining that the set of packets are addressed only to the UE.

In a second aspect, alone or in combination with the first aspect, process 700 includes performing a receiver ID filtering operation on the plurality of broadcast sidelink communication protocol vehicular communication packets, wherein determining that the set of packets are addressed to the UE comprises determining that the set of packets are addressed to the UE based at least in part on performing the receiver ID filtering operation.

In a third aspect, alone or in combination with the second aspect, the receiver ID is indicated in a MAC header associated with an access layer of a broadcast vehicular communication protocol stack.

In a fourth aspect, alone or in combination with the third aspect, the MAC header comprises a version field, and a value of the version field indicates that the packet is a unicast communication.

In a fifth aspect, alone or in combination with one or more of the third or fourth aspects, process 700 includes determining that the MAC header indicates the receiver ID using a first addressing space of a plurality of addressing spaces, wherein the first addressing space indicates one-to-one communications.

In a sixth aspect, alone or in combination with the fifth aspect, a second addressing space of the plurality of addressing spaces indicates broadcast communications.

In a seventh aspect, alone or in combination with one or more of the second through sixth aspects, the receiver ID is indicated in an application layer of a broadcast vehicular communication protocol stack.

In an eighth aspect, alone or in combination with the seventh aspect, the receiver ID comprises one or more values of one or more application layer parameters that correspond to the UE.

In a ninth aspect, alone or in combination with the eighth aspect, the one or more application layer parameters indicate at least one of a transaction ID, an application layer ID, a user address, a geolocation of the UE, or a charging rate associated with an application.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with various aspects of the present disclosure. Example process 800 is an example where the UE (e.g., UE 610) performs operations associated with one-to-one broadcast sidelink communication protocol vehicular communications.

As shown in FIG. 8, in some aspects, process 800 may include generating a set of broadcast sidelink communication protocol vehicular communication packets addressed only to a receiving UE based at least in part on indicating a receiver ID corresponding to the receiving UE in a protocol layer of a broadcast communication protocol stack (block 810). For example, the UE (e.g., using determination component 908, depicted in FIG. 9) may generate a set of broadcast sidelink communication protocol vehicular communication packets addressed only to a receiving UE based at least in part on indicating a receiver ID corresponding to the receiving UE in a protocol layer of a broadcast communication protocol stack, as described above.

As further shown in FIG. 8, in some aspects, process 800 may include transmitting the set of broadcast sidelink communication protocol vehicular communication packets (block 820). For example, the UE (e.g., using transmission component 904, depicted in FIG. 9) may transmit the set of broadcast sidelink communication protocol vehicular communication packets, as described above.

Process 800 may include additional aspects, such as any single aspect or any combination of aspects described below and/or in connection with one or more other processes described elsewhere herein.

In a first aspect, the receiver ID is indicated in a MAC header associated with an access layer of the broadcast vehicular communication protocol stack.

In a second aspect, alone or in combination with the first aspect, the MAC header comprises a version field, and a value of the version field indicates that the packet is a unicast communication.

In a third aspect, alone or in combination with one or more of the first and second aspects, the MAC header indicates the receiver ID using a first addressing space of a plurality of addressing spaces, wherein the first addressing space indicates one-to-one communications.

In a fourth aspect, alone or in combination with the third aspects, a second addressing space of the plurality of addressing spaces indicates broadcast communications.

In a fifth aspect, alone or in combination with one or more of the first through fourth aspects, the receiver ID is indicated in an application layer of the broadcast vehicular communication protocol stack.

In a sixth aspect, alone or in combination with the fifth aspect, the receiver ID comprises one or more values of one or more application layer parameters that correspond to the receiving UE.

In a seventh aspect, alone or in combination with the sixth aspect, the one or more application layer parameters indicate at least one of a transaction ID, an application layer ID, a user address, a geolocation of the receiving UE, or a charging rate associated with an application.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a determination component 908.

In some aspects, the apparatus 900 may be configured to perform one or more operations described herein in connection with FIGS. 6-8. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The reception component 902 may receive a plurality of broadcast sidelink communication protocol vehicular communication packets. The determination component 908 may process a set of packets of the plurality of broadcast sidelink communication protocol vehicular communication packets based at least in part on a determination that the set of packets are addressed only to the UE. The determination component 908 may determine that the set of packets are addressed only to the UE.

The determination component 908 may perform a receiver ID filtering operation on the plurality of broadcast sidelink communication protocol vehicular communication packets, wherein determining that the set of packets are addressed to the UE comprises determining that the set of packets are addressed to the UE based at least in part on performing the receiver ID filtering operation. The determination component 908 may determine that the MAC header indicates the receiver ID using a first addressing space of a plurality of addressing spaces, wherein the first addressing space indicates one-to-one communications.

The determination component 908 may generate a set of broadcast sidelink communication protocol vehicular communication packets addressed only to a receiving UE based at least in part on indicating a receiver ID corresponding to the receiving UE in a protocol layer of a broadcast vehicular communication protocol stack. The transmission component 904 may transmit the set of broadcast sidelink communication protocol vehicular communication packets.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of aspects of the present disclosure:

Aspect 1: A method of wireless communication performed by a UE, comprising: receiving a plurality of broadcast sidelink communication protocol vehicular communication packets; and processing a set of packets of the plurality of broadcast sidelink communication protocol vehicular communication packets based at least in part on a determination that the set of packets are addressed only to the UE.

Aspect 2: The method of aspect 1, further comprising determining that the set of packets are addressed only to the UE.

Aspect 3: The method of aspect 2, further comprising performing a receiver identifier (ID) filtering operation on the plurality of broadcast sidelink communication protocol vehicular communication packets, wherein determining that the set of packets are addressed to the UE comprises determining that the set of packets are addressed to the UE based at least in part on performing the receiver ID filtering operation.

Aspect 4: The method of aspect 3, wherein the receiver ID is indicated in a medium access control (MAC) header associated with an access layer of a broadcast vehicular communication protocol stack.

Aspect 5: The method of aspect 4, wherein the MAC header comprises a version field, and wherein a value of the version field indicates that the packet is a unicast communication.

Aspect 6: The method of either of aspects 4 or 5, further comprising determining that the MAC header indicates the receiver ID using a first addressing space of a plurality of addressing spaces, wherein the first addressing space indicates one-to-one communications.

Aspect 7: The method of aspect 6, wherein a second addressing space of the plurality of addressing spaces indicates broadcast communications.

Aspect 8: The method of any of aspects 3-7, wherein the receiver ID is indicated in an application layer of a broadcast vehicular communication protocol stack.

Aspect 9: The method of aspect 8, wherein the receiver ID comprises one or more values of one or more application layer parameters that correspond to the UE.

Aspect 10: The method of aspect 9, wherein the one or more application layer parameters indicate at least one of: a transaction ID, an application layer ID, a user address, a geolocation of the UE, or a charging rate associated with an application.

Aspect 11: A method of wireless communication performed by a UE, comprising: generating a set of broadcast sidelink communication protocol vehicular communication packets addressed only to a receiving UE based at least in part on indicating a receiver ID corresponding to the receiving UE in a protocol layer of a broadcast vehicular communication protocol stack; and transmitting the set of broadcast sidelink communication protocol vehicular communication packets.

Aspect 12: The method of aspect 11, wherein the receiver ID is indicated in a MAC header associated with an access layer of the broadcast vehicular communication protocol stack.

Aspect 13: The method of aspect 12, wherein the MAC header comprises a version field, and wherein a value of the version field indicates that the packet is a unicast communication.

Aspect 14: The method of either of aspects 12 or 13, wherein the MAC header indicates the receiver ID using a first addressing space of a plurality of addressing spaces, wherein the first addressing space indicates one-to-one communications.

Aspect 15: The method of aspect 14, wherein a second addressing space of the plurality of addressing spaces indicates broadcast communications.

Aspect 16: The method of any of aspects 11-15, wherein the receiver ID is indicated in an application layer of the broadcast vehicular communication protocol stack.

Aspect 17: The method of aspect 16, wherein the receiver ID comprises one or more values of one or more application layer parameters that correspond to the receiving UE.

Aspect 18: The method of aspect 17, wherein the one or more application layer parameters indicate at least one of: a transaction ID, an application layer ID, a user address, a geolocation of the receiving UE, or a charging rate associated with an application.

Aspect 19: An apparatus for wireless communication at a first device, comprising a processor; memory coupled with the processor; and instructions stored in the memory and executable by the processor to cause the apparatus to perform a method of any of aspects 1 through 10.

Aspect 20: An apparatus for wireless communication at a first device, comprising at least one means for performing a method of any of aspects 1 through 10.

Aspect 21: A non-transitory computer-readable medium storing code for wireless communication at a first device, the code comprising instructions executable by a processor to perform a method of any of aspects 1 through 10.

Aspect 22: An apparatus for wireless communication at a first device, comprising a processor; memory coupled with the processor; and instructions stored in the memory and executable by the processor to cause the apparatus to perform a method of any of aspects 11 through 18.

Aspect 23: An apparatus for wireless communication at a first device, comprising at least one means for performing a method of any of aspects 11 through 18.

Aspect 24: A non-transitory computer-readable medium storing code for wireless communication at a first device, the code comprising instructions executable by a processor to perform a method of any of aspects 11 through 18.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a plurality of broadcast sidelink communication protocol vehicular communication packets; and
processing a set of packets of the plurality of broadcast sidelink communication protocol vehicular communication packets based at least in part on a determination that the set of packets are addressed only to the UE.

2. The method of claim 1, further comprising determining that the set of packets are addressed only to the UE.

3. The method of claim 2, further comprising performing a receiver identifier (ID) filtering operation on the plurality of broadcast sidelink communication protocol vehicular communication packets,
wherein determining that the set of packets are addressed to the UE comprises determining that the set of packets are addressed to the UE based at least in part on performing the receiver ID filtering operation.

4. The method of claim 3, wherein the receiver ID is indicated in a medium access control (MAC) header associated with an access layer of a broadcast vehicular communication protocol stack.

5. The method of claim 4, wherein the MAC header comprises a version field, and wherein a value of the version field indicates that the packet is a unicast communication.

6. The method of claim 4, further comprising determining that the MAC header indicates the receiver ID using a first addressing space of a plurality of addressing spaces, wherein the first addressing space indicates one-to-one communications.

7. The method of claim 6, wherein a second addressing space of the plurality of addressing spaces indicates broadcast communications.

8. The method of claim 3, wherein the receiver ID is indicated in an application layer of a broadcast vehicular communication protocol stack.

9. The method of claim 8, wherein the receiver ID comprises one or more values of one or more application layer parameters that correspond to the UE.

10. The method of claim 9, wherein the one or more application layer parameters indicate at least one of:
a transaction ID,
an application layer ID,
a user address,
a geolocation of the UE, or
a charging rate associated with an application.

11. A method of wireless communication performed by a user equipment (UE), comprising:
generating a set of broadcast sidelink communication protocol vehicular communication packets addressed only to a receiving UE based at least in part on indicating a receiver identifier (ID) corresponding to the receiving UE in a protocol layer of a broadcast vehicular communication protocol stack; and
transmitting the set of broadcast sidelink communication protocol vehicular communication packets.

12. The method of claim 11, wherein the receiver ID is indicated in a medium access control (MAC) header associated with an access layer of the broadcast vehicular communication protocol stack.

13. The method of claim 12, wherein the MAC header comprises a version field, and wherein a value of the version field indicates that the packet is a unicast communication.

14. The method of claim 12, wherein the MAC header indicates the receiver ID using a first addressing space of a plurality of addressing spaces, wherein the first addressing space indicates one-to-one communications.

15. The method of claim 14, wherein a second addressing space of the plurality of addressing spaces indicates broadcast communications.

16. The method of claim 11, wherein the receiver ID is indicated in an application layer of the broadcast vehicular communication protocol stack.

17. The method of claim 16, wherein the receiver ID comprises one or more values of one or more application layer parameters that correspond to the receiving UE.

18. The method of claim 17, wherein the one or more application layer parameters indicate at least one of:
a transaction ID,
an application layer ID,
a user address,
a geolocation of the receiving UE, or
a charging rate associated with an application.

19. A user equipment (UE) for wireless communication, comprising:
a memory; and
one or more processors coupled to the memory, the memory and the one or more processors configured to:
receive a plurality of broadcast sidelink communication protocol vehicular communication packets; and
process a set of packets of the plurality of broadcast sidelink communication protocol vehicular communication packets based at least in part on a determination that the set of packets are addressed only to the UE.

20. The UE of claim 19, wherein the one or more processors are further configured to determine that the set of packets are addressed only to the UE.

21. The UE of claim 20, wherein the one or more processors are further configured to perform a receiver identifier (ID) filtering operation on the plurality of broadcast sidelink communication protocol vehicular communication packets,
wherein the one or more processors, when determining that the set of packets are addressed to the UE, are configured to determine that the set of packets are addressed to the UE based at least in part on performing the receiver ID filtering operation.

22. The UE of claim 21, wherein the receiver ID is indicated in a medium access control (MAC) header associated with an access layer of a broadcast vehicular communication protocol stack.

23. The UE of claim 22, wherein the MAC header comprises a version field, and wherein a value of the version field indicates that the packet is a unicast communication.

24. The UE of claim 22, wherein the one or more processors are further configured to determine that the MAC header indicates the receiver ID using a first addressing space of a plurality of addressing spaces, wherein the first addressing space indicates one-to-one communications.

25. The UE of claim 24, wherein a second addressing space of the plurality of addressing spaces indicates broadcast communications.

26. (canceled)

27. (canceled)

28. (canceled)

29. A user equipment (UE) for wireless communication, comprising:
a memory; and
one or more processors coupled to the memory, the memory and the one or more processors configured to:
generate a set of broadcast sidelink communication protocol vehicular communication packets addressed only to a receiving UE based at least in part on indicating a receiver identifier (ID) corresponding to the receiving UE in a protocol layer of a broadcast vehicular communication protocol stack; and
transmit the set of broadcast sidelink communication protocol vehicular communication packets.

30. The UE of claim 29, wherein the receiver ID is indicated in a medium access control (MAC) header associated with an access layer of the broadcast vehicular communication protocol stack.

31. The UE of claim 30, wherein the MAC header comprises a version field, and wherein a value of the version field indicates that the packet is a unicast communication.

32. The UE of claim 30, wherein the MAC header indicates the receiver ID using a first addressing space of a plurality of addressing spaces, wherein the first addressing space indicates one-to-one communications.

33. The UE of claim 32, wherein a second addressing space of the plurality of addressing spaces indicates broadcast communications.

34. (canceled)

35. (canceled)

36. (canceled)

37. (canceled)

38. (canceled)

39. (canceled)

40. (canceled)
